(19) United States
(12) Patent Application Publication
(10) Pub. No.: US 2026/0231035 A1
(43) Pub. Date: Aug. 6, 2026

(54) INTRA-RAN SIGNALING TO SUPPORT ON-DEMAND SIB1

(71) Applicant: QUALCOMM Incorporated, San Diego, CA (US)

(72) Inventors: Navid ABEDINI, Basking Ridge, NJ (US); Karl Georg HAMPEL, Jersey City, NJ (US)

(21) Appl. No.: 19/431,957

(22) Filed: Dec. 23, 2025

Related U.S. Application Data
(60) Provisional application No. 63/752,335, filed on Jan. 31, 2025.

(51) Int. Cl. H04W 52/02; H04W 52/14

(52) U.S. Cl. CPC H04W 52/0235

(57) ABSTRACT

Apparatus, methods, and computer program products for wireless communication are provided. An example method may include transmitting, to a cell-anchor (cell-A) network node, a request to transmit a set of uplink (UL) wake-up signal (WUS) (UL-WUS) configurations, where the request includes an indication of a first list of NES cells associated with the set of UL-WUS configurations. The example method may further include receiving, from the cell-A network node, a response to the request, where the response is associated with a set of cell-A cells associated with a transmission of the set of UL-WUS configurations.

### CROSS REFERENCE TO RELATED APPLICATION(S)

This application claims the benefit of and priority to U.S. Provisional Application Ser. No. 63/752,335, entitled “INTRA-RAN SIGNALING TO SUPPORT ON-DEMAND SIB1” and filed on Jan. 31, 2025, which is expressly incorporated by reference herein in its entirety.

### TECHNICAL FIELD

The present disclosure relates generally to communication systems, and more particularly, to wireless communication systems with on-demand system information block (SIB).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a network energy saving (NES) network node are provided. The apparatus may include at least one memory and at least one processor coupled to the at least one memory. Based at least in part on information stored in the at least one memory, the at least one processor, individually or in any combination, is configured to (e.g., cause the NES network node to) transmit, to a cell-anchor (cell-A) network node, a request to transmit a set of uplink (UL) wake-up signal (WUS) (UL-WUS) configurations, where the request includes an indication of a first list of NES cells associated with the set of UL-WUS configurations. Based at least in part on information stored in the at least one memory, the at least one processor, individually or in any combination, is configured to receive, from the cell-A network node, a response to the request, where the response is associated with a set of cell-A cells associated with a transmission of the set of UL-WUS configurations.

In another aspect of the disclosure, a method, a computer-readable medium, and an apparatus at a cell-A network node are provided. The apparatus may include at least one memory and at least one processor coupled to the at least one memory. Based at least in part on information stored in the at least one memory, the at least one processor, individually or in any combination, is configured to receive, from a network energy saving (NES) network node, a request to transmit a set of uplink (UL) wake-up signal (WUS) (UL-WUS) configurations, where the request includes an indication of a first list of NES cells associated with the set of UL-WUS configurations. Based at least in part on information stored in the at least one memory, the at least one processor, individually or in any combination, is configured to transmit, to NES network node, a response to the request, where the response is associated with a set of cell-A cells associated with a transmission of the set of UL-WUS configurations.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example communications between network nodes to facilitate transmissions of uplink (UL) wake-up signal (WUS) (UL-WUS) configurations, in accordance with various aspects of the present disclosure.

FIG. 5 is a diagram illustrating example communications between network nodes to facilitate transmissions of UL-WUS configurations, in accordance with various aspects of the present disclosure.

FIG. 6 is a flowchart of a method of wireless communication, in accordance with various aspects of the present disclosure.

FIG. 7 is a flowchart of a method of wireless communication, in accordance with various aspects of the present disclosure.

FIG. 8 is a diagram illustrating an example of a hardware implementation for a network entity.

FIG. 9 is a diagram illustrating an example of a hardware implementation for a network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

A cell anchor (cell-A) may be a cell that is periodically transmitting at least its own system information block 1 (SIB1) and may transmit uplink (UL)-wake-up signal (WUS) (UL-WUS) for network energy saving (NES) cells. A NES cell may be a cell that may transmit SIB1 transmission in response to UL-WUS from a user equipment (UE). A UE obtains the UL-WUS configuration from cell-A, and may transmit UL-WUS to NES Cell. UL-WUS configuration from NES cell to cell-A via Xn interface, e.g., before entering on-demand SIB1 mode in the NES cell or when the UL-WUS configuration is changed. The UL-WUS configuration may be included transmission from NES cell distributed to NES cell. NES network node may send UL-WUS configuration to cell-A network node over Xn Interface. Upon the reception of the UL-WUS configuration, cell-A can provide feedback to NES cell on whether the WUS configuration transmission for NES cell is accepted in cell-A (e.g., confirm, reject). Aspects provided herein may provide backhaul signaling mechanisms for transmission of UL-WUS configurations for NES cells.

The example aspects described herein may provide various benefits by enabling a coordinated and channel-aware mechanism for managing UL-WUS configurations between NES cells and cell-A cells, and these benefits may improve signaling efficiency, reduce broadcast activity, promote energy-saving behavior across heterogeneous network deployments, and improve overall communication efficiency. By allowing an NES network node to transmit a request that may include a first list of NES cells, a set of UL-WUS configurations, and an indication of requested cell-A cells, the signaling exchange may enable a centralized or semi-centralized decision process in which the cell-A network node may determine whether specific UL-WUS configurations may be transmitted for individual NES cells or NES cell groups. Such an exchange may allow the cell-A network node to confirm, reject, or cease the transmission of UL-WUS configurations based on its local context, such as available broadcast capacity, overlapping coverage relationships, or operational constraints, and this selective acceptance mechanism may prevent situations in which excessive UL-WUS signaling may burden cell-A resources, improving overall communication efficiency. The ability for the NES network node to receive, from the cell-A network node, a response that includes confirmed, rejected, or ceased cell-A cells for each NES cell, each cell-A cell, or each UL-WUS configuration may also enable a more predictable operating environment where the NES side may adapt its SIB1 on-demand activation strategy, timing behavior, and UL-WUS triggering logic based on explicit feedback rather than assumptions. The ability for the NES CU to activate or deactivate on-demand SIB1 transmission for each NES cell based on the feedback from the cell-A network node may permit a dynamic adjustment process that may be responsive to cell-A availability or coverage interactions, allowing NES cells to operate with reduced broadcast activity when possible. Example aspects may also allow the cell-A network node to maintain knowledge of the NES cell landscape through the first list of NES cells or through candidate cell-A lists reported by neighbor nodes, which may simplify coordination and help avoid misaligned UL-WUS behavior.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

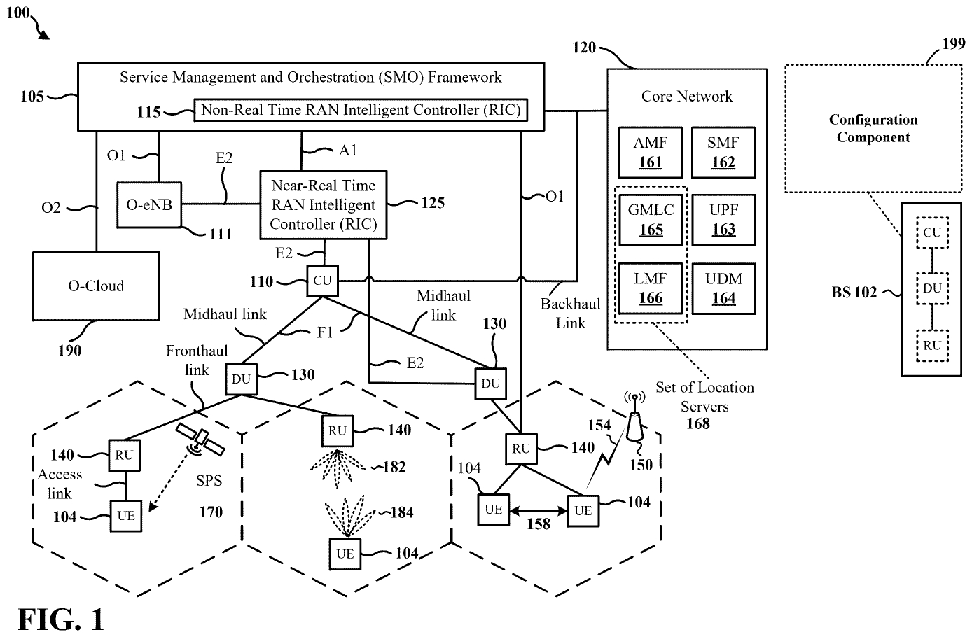

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the base station 102 may include a configuration component 199. In some aspects, the configuration component 199 may be configured to transmit, to a cell-anchor (cell-A) network node, a request to transmit a set of uplink (UL) wake-up signal (WUS) (UL-WUS) configurations, where the request includes an indication of a first list of NES cells associated with the set of UL-WUS configurations. In some aspects, the configuration component 199 may be further configured to receive, from the cell-A network node, a response to the request, where the response is associated with a set of cell-A cells associated with a transmission of the set of UL-WUS configurations.

In some aspects, the configuration component 199 may be configured to receive, from a network energy saving (NES) network node, a request to transmit a set of uplink (UL) wake-up signal (WUS) (UL-WUS) configurations, where the request includes an indication of a first list of NES cells associated with the set of UL-WUS configurations. In some aspects, the configuration component 199 may be further configured to transmit, to NES network node, a response to the request, where the response is associated with a set of cell-A cells associated with a transmission of the set of UL-WUS configurations.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

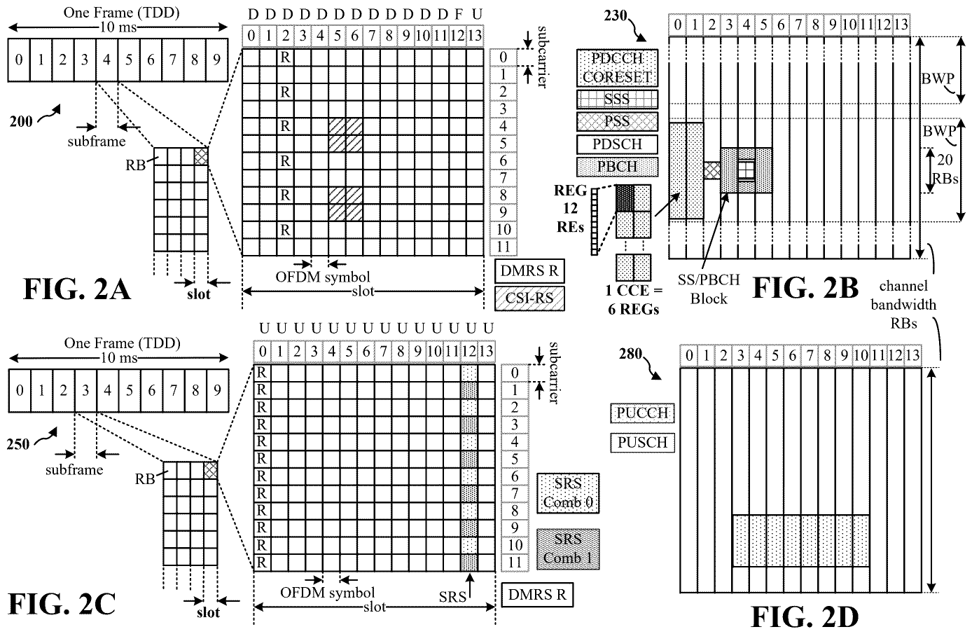

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

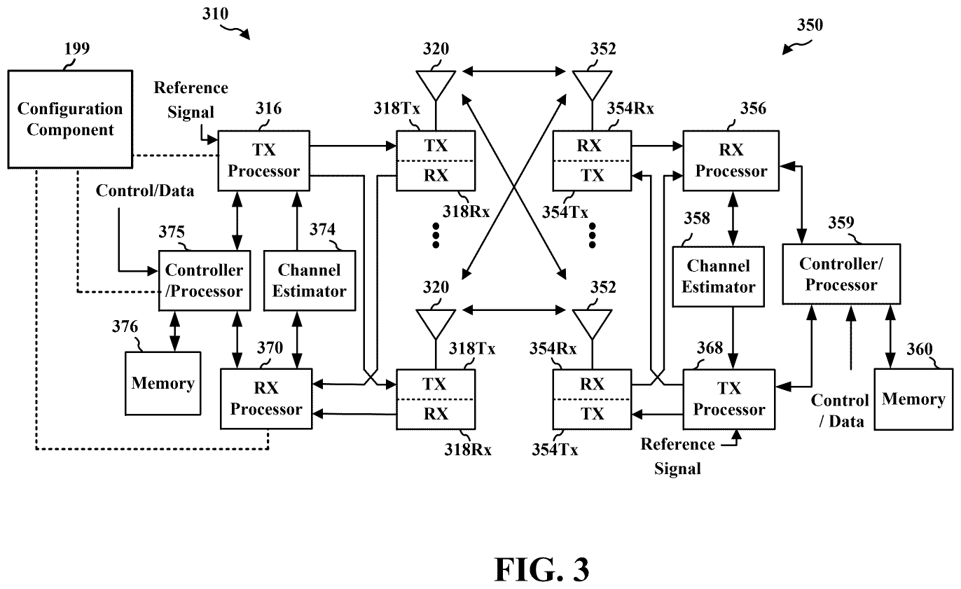

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with configuration component 199 of FIG. 1.

The term “camp” may refer to a state where a UE has successfully completed the process of selecting and registering with a particular cell in the network. When the UE is camped on a cell, the UE may receive and transmit data based on that cell. MIB may provide information used to acquire other system information (e.g., SIB) and may include system frame number, subcarrier spacing, and cell bandwidth. There may be various types of SIB. SIB1 may be SIB that includes information for initial access to the network, such as cell access-related parameters, public land mobile network (PLMN) identity, and scheduling information for other SIBs. SIB2 may provide radio resource configuration information common for all UEs in the cell and may include parameters for physical layer configuration and random access procedures. SIB3 may include cell re-selection information used by UEs in idle mode. Example parameters included in SIB3 may include parameters related to intra-frequency, inter-frequency, and inter-radio access technology cell re-selection. Other SIBs, such as SIB4 and SIB5, may include additional information that can be used for various purposes like inter-frequency measurements, inter-RAT re-selection, and specific service information. As used herein, the term “SIB X” may refer to an SIB that is not SIB1. As used herein, the term “anchor cell or cell-A” may refer to a cell that is periodically transmitting its own SIB1. To facilitate energy saving at network nodes, some cells/network nodes may not be periodically transmitting its own SIB1, but rather transmit SIB1 in response to a “uplink wake-up signal (UL-WUS)” from a UE. Such SIB1 in response to a UL-WUS may be referred to as on-demand (OD) SIB. As used herein, the term “network energy saving (NES) cell” may refer to a cell that transmits SIB1 in response to a UL-WUS and does not periodically transmit its own SIB1. As used herein, the term “UL-WUS” may refer to a transmission that triggers an NES cell to transmit SIB1. As used herein, the term “UL-WUS configuration” may refer to a configuration for transmission of UL-WUS, which may include identifier (ID), such as physical cell ID and frequency of at least one cell associated with the UL-WUS configuration (e.g., at least one cell where the UL-WUS configuration may be applicable for). The UL-WUS configuration may also be referred to as an OD-SIB or OD-SIB 1 configuration (e.g., because it triggers an OD SIB1). The UL-WUS configuration may further include configurations related to the transmission of the UL-WUS, such as SIB1-request configuration that may include SS/PBCH block power, RACH occasion for SIB1, SIB1 request period, SIB1 request resource, or the like. The UL-WUS configuration may also include frequency information for uplink such as frequency band list, offset to carrier, frequency shift, or the like. The UL-WUS configuration may also include configurations related to reception of SIB1, such as a PDCCH configuration associated with the SIB1 that would be transmitted by the NES cell upon receiving the UL-WUS. The UL-WUS configuration may also include SSB position in burst, or other SSB related configurations. A UL-WUS may be alternatively referred to as “PRACH to request SIB1” or similar terminology.

A cell-A may be a cell that is periodically transmitting at least its own SIB1 and may transmit UL-WUS configurations for NES cells so that a UE may transmit, based on a UL-WUS configuration, for a particular NES cell, a UL-WUS. A NES cell may be a cell that may transmit SIB1 transmission in response to UL-WUS from a UE. A UE obtains the UL-WUS configuration from cell-A, and may transmit UL-WUS to NES Cell. The NES cell network node may send the UL-WUS configuration to a cell-A network node via Xn interface, e.g., before entering on-demand SIB1 mode in the NES cell or when the UL-WUS configuration is changed. The UL-WUS configuration may be included transmission from gNB-DU to gNB-CU. A NES-cell gNB is a gNB that supports NES cells. A cell-A gNG may be a gNB that supports cell-A. NES gNB-CU sends UL-WUS configuration to cell-A gNB-CU over Xn Interface. Upon the reception of the UL-WUS configuration, cell-A can provide feedback to NES cell on whether the WUS configuration transmission for NES cell is accepted in cell-A (e.g., confirm, reject). Aspects provided herein may provide intra or inter RAN-node signaling mechanisms for transmission of UL-WUS configurations for NES cells. The UL-WUS configuration may be transferred over Xn via a class 1 defined procedure where cell-A gNB can decide and signal to NES cell gNB that it stops the UL-WUS configuration transmission (e.g., broadcast or unicast) in its SIB. In some aspects, for connected UEs or when UL-WUS is included in cell-A's upper SIBs, the UL-WUS configuration may be transmitted via unicast. A class 2 procedure may be introduced for cell-A gNB to signal to NES cell gNB that it stops the UL-WUS configuration broadcast in its SIB, or introduced for NES cell gNB to update the request for UL-WUS configuration transmission. A served cell information information element (IE) may be used to include UL-WUS configuration from gNB-DU to gNB-CU in F1 setup request and gNB-DU configuration update procedures. There may be multiple NES cells belonging to the same NES network node, such as a NES gNB, a NES DU, or a NES CU. For each NES cell, there may be one or multiple associated cell-A(s) that may be used or confirmed to send the UL-WUS configuration. Specifically, cell-A(s) may be selected have an overlapping coverage with the associated NES cell(s).

As used herein, the term “a request to transmit a set of UL-WUS configurations” may refer to a backhaul signaling from a NES network node (e.g., a NES CU or a NES base station) to a cell-A network node (e.g., a cell-A CU or a cell-A base station) to request cell-A DU or the cell-A base station to transmit the set of UL-WUS configurations to UEs for the NES network node (e.g., for the NES base station itself or for a NES DU associated with the NES CU). As used herein, the term “a set of UL-WUS configurations” may refer to one or more UL-WUS configuration, where each UL-WUS configuration may be associated with at least one NES cell. In some aspects, the request may include a first list of NES cells associated with the set of UL-WUS configurations, which may include all of the NES cell(s) associated with each UL-WUS configuration of the set of UL-WUS configurations. In some aspects, the request may include an indication of a list of requested cell-A cells requested to be associated with the transmission of the set of UL-WUS configurations (e.g., indexed based on the list of NES cells or the set of UL-WUS configurations). In some aspects, a list may include one or more elements (such as one or more cells or one or more configurations).

As used herein, the term “a response to the request to transmit the set of UL-WUS configurations” or “a response to the request” may refer to a response from the cell-A network node that indicates a set of cell-A cells associated with a transmission of the set of UL-WUS configurations. The set of cell-A cells may include, for each NES cell or each NES cell group, or each UL-WUS configuration, at least one cell that may be: (1) confirmed for transmission of the corresponding UL-WUS configuration, (2) rejected for transmission of the corresponding UL-WUS configuration, and (3) previously confirmed for transmission of the corresponding UL-WUS configuration but would cease transmission of the corresponding UL-WUS configuration. In some aspects, the response may indicate the set of cell-A cells by confirming or rejecting the requested list of requested cell-A cells. In some aspects, the response may indicate the set of cell-A cells by separately indicating the requested cell-A cells (e.g., based on a respective cell identifier(s) or based on an index given by the request).

As used herein, the term “a list” or “a set” may refer to a list or a set of one or more entities, such as indication(s) of UL-WUS configuration or cell.

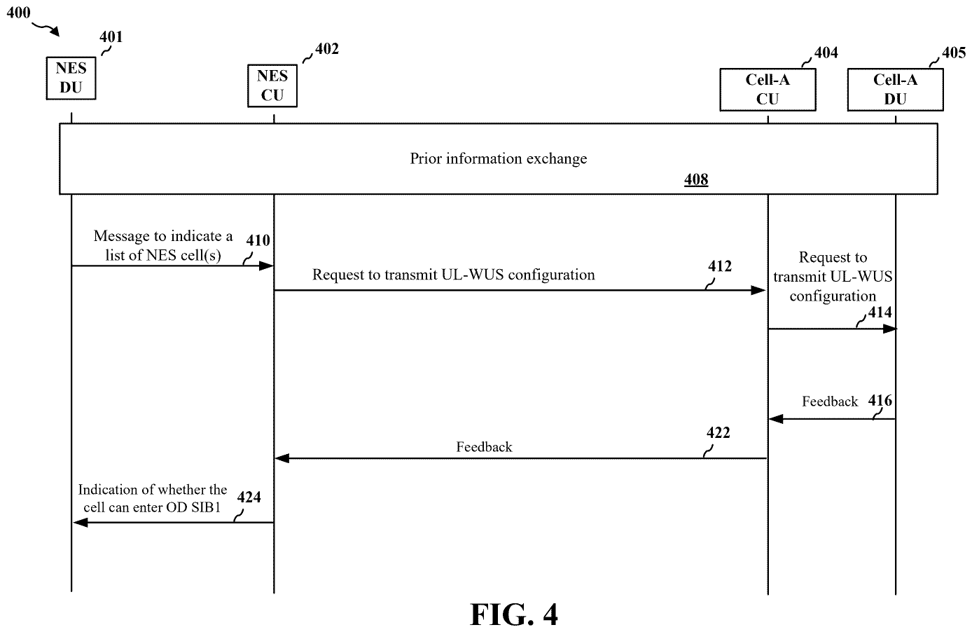

FIG. 4 is a diagram 400 illustrating example communications between network nodes, including a NES DU 401, a NES CU 402, a cell-A CU 404, and a cell-A DU 405, to facilitate transmissions of UL-WUS configurations, in accordance with various aspects of the present disclosure.

In some aspects, the NES DU 401 sends a message 410 to NES CU 402 (e.g., over F1 interface) to indicate a list of one or multiple NES cells (belonging to the NES DU 401). In some aspects, for each NES cell (or for each group of NES cells), the message 410 may include the associated one or more cell-A(s) that are requested/suggested to transmit the UL-WUS configuration. In some aspects, no associated cell-A(s) is indicated.

As illustrated in FIG. 4, the NES CU 402 sends a request 412 to cell-A DU 405, over Xn interface, to transmit (broadcast) one or multiple UL-WUS configuration(s), where the request 412 includes for each UL-WUS configuration a list of one or multiple NES cells (belonging to NES CU 402). In some aspects, for each NES cell (or for each group of NES cells), the request 412 may include information of the associated one or multiple cell-A(s) (belonging to cell-A DU 405) that are requested to transmit the UL-WUS configuration. In some aspects, no associated cell-A(s) is indicated (i.e., cell-A DU 405 can decide on which cell-A(s) to transmit the UL-WUS configuration). In some aspects, the request 412 may include an index value for each UL-WUS configuration.

In some aspects, the cell-A CU 404 sends a request 414 to cell-A DU 405, over F1 interface, to transmit (broadcast) one or more UL-WUS configuration(s). In some aspects, the request 414 includes, for each UL-WUS configuration, a list of one or more NES cells (belonging to NES DU 401). In some aspects, for each NES cell (or for each group of NES cells), the request 414 includes the associated one or more cell-A(s) (belonging to cell-A CU 404) that are requested to transmit the UL-WUS configuration. In some aspects, no associated cell-A(s) is indicated (i.e., cell-A CU 404 can decide on which cell-A(s) to transmit the UL-WUS configuration). In some aspects, the request may include an index value for each UL-WUS configuration.

In some aspects, cell-A CU 404 sends a message 422 to NES CU 402 (e.g., over Xn interface), to provide feedback about transmission of UL-WUS configuration. In some aspects, the message may be in response to the NES CU 402's request. In some aspects, the message may be sent at any given time (e.g., if at a later stage, the cell-A CU 404 decides to change/update its configuration). In some aspects, the message 422 may include, for each NES cell (or for each group of NES cells), belonging to NES CU 402: (1) a list of one or more cell-A(s) (belonging to cell-A CU 404) that are confirmed to transmit the UL-WUS configuration, (2) a list of one or more cell-A(s) (belonging to cell-A CU 404) that are not confirmed (rejected) to transmit the UL-WUS configuration, (3) a list of one or more cell-A(s) (belonging to cell-A CU 404) that will stop (cease) transmitting the UL-WUS configuration, or (4) an indication of at least one indicator that indicates confirm/reject/stop, with no indication of associated cell-A(s). When rejecting or confirming the request from NES CU 402 for all indicated cell-A(s) (in NES CU 402's request), in some aspects, the message may include a flag (confirm/reject/stop), with no indication of associated cell-A(s).

In some aspects, the message 422 may include, for each cell-A (or for each group of cell-As), belonging to cell-A CU 404: (1) a list of one or more NES cell(s) (belonging to NES cell CU), for which the transmission of the UL-WUS configuration is confirmed, (2) a list of one or more NES cell(s) (belonging to NES cell CU), for which the transmission of the UL-WUS configuration is rejected, (3) a list of one or more NES cell(s) (belonging to NES cell CU), for which the transmission of the UL-WUS configuration will be stopped, or (4) at least one indicator that indicates confirm/reject/stop, with no indication of associated NES cell(s). In some aspects, when rejecting or confirming the request from NES CU 402 for all associated NES cell(s) (in NES CU 402's request), the message 422 may include a simple flag (confirm/reject/stop), with no indication of associated NES cell(s).

In some aspects, the message 422 may include, for each UL-WUS configuration requested for transmission: (1) a list of one or more cell-A(s) (belonging to cell-A CU 404) that are confirmed to transmit the UL-WUS configuration, (2) a list of one or more cell-A(s) (belonging to cell-A CU 404) that are not confirmed (rejected) to transmit the UL-WUS configuration, (3) a list of one or more cell-A(s) (belonging to cell-A CU 404) that may stop transmitting the UL-WUS configuration, or (4) at least one indicator that indicates confirm/reject/stop, with no indication of associated NES cell(s). In some aspects, rejecting or confirming the request from NES CU 402 for all indicated UL-WUS configurations (in NES CU 402's request), the message 422 may include a flag (confirm/reject/stop), with no indication of associated NES cell(s). In some aspects, the message 422 may be feedback and may use an index to refer to an UL-WUS configuration, where the index may have been copied from the NES CU 402's request 412. In some aspects, when referring to cell-A(s) (or NES cell(s)) in the feedback message 422, the full cell identifiers (IDs) may be included or an index (with fewer number of bits) to the list of requested/indicated cell-A(s) (or NES cell(s)), sent earlier by the NES CU 402.

In some aspects, the message 422 may be based on a message 416 of the request 414. The message 416 would be the feedback from the cell-A DU 405. In some aspects, the message 416 may be over F1 interface to provide feedback about transmission of UL-WUS configuration. In some aspects, the message 416 may be in response to the cell-A CU 404's request/indication. In some aspects, the message 416 may be sent at any given time (e.g., if at a later stage, the cell-A DU 405 decides to change/update its configuration).

In some aspects, the message 416 may include, for each NES cell (or for each group of NES cells), belonging to NES CU 402: (1) a list of one or more cell-A(s) (belonging to cell-A CU 404) that are confirmed to transmit the UL-WUS configuration, (2) a list of one or more cell-A(s) (belonging to cell-A CU 404) that are not confirmed (rejected) to transmit the UL-WUS configuration, (3) a list of one or more cell-A(s) (belonging to cell-A CU 404) that will stop (cease) transmitting the UL-WUS configuration, or (4) an indication of at least one indicator that indicates confirm/reject/stop, with no indication of associated cell-A(s). When rejecting or confirming the request from NES CU 402 for all indicated cell-A(s) (in NES CU 402's request), in some aspects, the message may include a flag (confirm/reject/stop), with no indication of associated cell-A(s).

In some aspects, the message 416 may include, for each cell-A (or for each group of cell-As), belonging to cell-A CU 404: (1) a list of one or more NES cell(s) (belonging to NES cell CU), for which the transmission of the UL-WUS configuration is confirmed, (2) a list of one or more NES cell(s) (belonging to NES cell CU), for which the transmission of the UL-WUS configuration is rejected, (3) a list of one or more NES cell(s) (belonging to NES cell CU), for which the transmission of the UL-WUS configuration will be stopped, or (4) at least one indicator that indicates confirm/reject/stop, with no indication of associated NES cell(s). In some aspects, when rejecting or confirming the request from NES CU 402 for all associated NES cell(s) (in NES CU 402's request), the message 416 may include a simple flag (confirm/reject/stop), with no indication of associated NES cell(s).

In some aspects, the message 416 may include, for each UL-WUS configuration requested for transmission: (1) a list of one or more cell-A(s) (belonging to cell-A CU 404) that are confirmed to transmit the UL-WUS configuration, (2) a list of one or more cell-A(s) (belonging to cell-A CU 404) that are not confirmed (rejected) to transmit the UL-WUS configuration, (3) a list of one or more cell-A(s) (belonging to cell-A CU 404) that may stop transmitting the UL-WUS configuration, or (4) at least one indicator that indicates confirm/reject/stop, with no indication of associated NES cell(s). In some aspects, rejecting or confirming the request from NES CU 402 for all indicated UL-WUS configurations (in NES CU 402's request), the message 416 may include a flag (confirm/reject/stop), with no indication of associated NES cell(s). In some aspects, the message 416 may be feedback and may use an index to refer to an UL-WUS configuration, where the index may have been copied from the NES CU 402's request 412. In some aspects, when referring to cell-A(s) (or NES cell(s)) in the feedback message 416, the full cell identifiers (IDs) may be included or an index (with fewer number of bits) to the list of requested/indicated cell-A(s) (or NES cell(s)), sent earlier by the cell-A CU 404.

In some aspects, based on the message 422, the NES CU 402 sends a message 424 to NES DU 401, over F1 interface, including for each NES cell-A, an indication of whether the cell can enter OD SIB1 mode.

In some aspects, there may be additional support information exchanged at 408. For example, over Xn interface, support information exchange between two CUs (cell-A CU 404 and NES CU 402) to determine the candidate cell-A(s) may be exchanged. The candidate cell-A(s) are those that can/may support transmitting UL-WUS configuration for other NES cell(s) and/or have overlapping coverage with other NES cell(s). The information exchange may include request from one CU (NES CU 402) to another CU (cell-A CU 404) to provide a list of candidate cell-A(s) (belonging to the cell-A CU 404). The request may be for an indicated set of one or more NES cell(s) (belonging to the NES CU 402). The information exchange may further include a request from one CU (NES CU 402) to another CU (cell-A CU 404) to check the availability/support of UL-WUS configuration transmission for a list of candidate cell-A(s) (belonging to the cell-A CU 404). The request may be for an indicated set of one or more NES cell(s) (belonging to the NES CU 402). In some aspects, the information exchange may include an indication from NES CU 402 to cell-A CU 404 of a list of NES cell(s) (belonging to the NES CU 402). In some aspects, the information exchange may include an indication (or response) from cell-A CU 404 to NES CU 402 including a list of candidate cell-A(s) (belonging to the cell-A CU 404). In some aspects, the indication may be for an indicated set of one or more NES cell(s) (belonging to the NES CU 402).

In some aspects, at 408, over F1 interface, there may be additional information exchange between CU and DU to determine the candidate cell-A(s) may be used. In some aspects, the information exchange may include a request from CU/DU to DU/CU to provide a list of candidate cell-A(s) (belonging to same or different CU/DU). In some aspects, the request may be for an indicated set of one or more NES cell(s). In some aspects, the information exchange may include a request from DU/CU to CU/DU to check the availability/support of UL-WUS configuration transmission for a list of candidate cell-A(s). In some aspects, the request may be for an indicated set of one or more NES cell(s). In some aspects, the information exchange may include an indication from DU/CU to CU/DU of a list of NES cell(s) (belonging to the same or different CU/DU). In some aspects, the information exchange may include an indication (or response) from CU/DU to DU/CU including a list of candidate cell-A(s) (belonging to the same or different CU/DU). In some aspects, the indication may be for an indicated set of one or more NES cell(s).

In all responses, configurations, requests, or other messages for different information exchanges, a time attribute may be added to (or requests/responses), where the time attribute may indicate the stop, start, and/or duration of time for an indicated configuration or action. A first CU (CU 1) may provide a second CU (CU 2, which may be the NES CU 402 or the cell-A CU 404) neighbor cell information of the cells belonging to a third CU (CU3, which may be NES CU 402 or the cell-A CU 404), where the neighbor cell information may include a list of one or more NES cell(s) belonging to the third CU (e.g., and the associated list of cell-A(s) belonging to CU3, CU1, or other CU), a list of one or more [candidate] cell-A(s) belonging to the third CU (e.g., and the associated list of one or more NES cells belonging to CU3, CU1, or other CU).

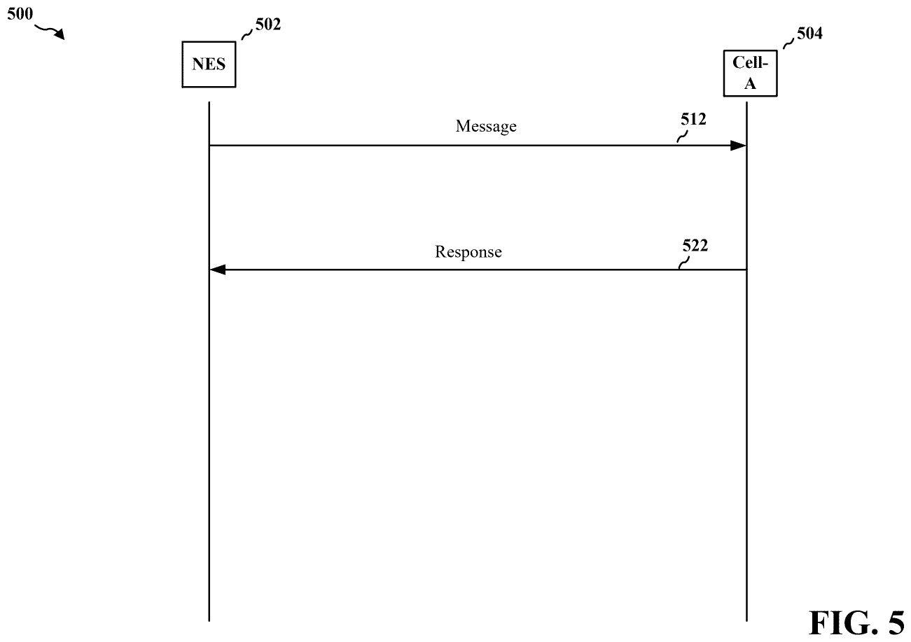

FIG. 5 is a diagram 500 illustrating example communications between network nodes, including NES network node 502 and cell-A network node 504, to facilitate transmissions of UL-WUS configurations, in accordance with various aspects of the present disclosure. Compared to the implementation to FIG. 4, the NES network node 502 and cell-A network node 504 may be standalone gNBs and may exchange request 512 and response 522, which corresponds to the request 412 and the message 422. Upon receiving the response 522, the NES network node 502 may accordingly activate or deactivate OD-SIB1 for each NES cell associated with the NES network node 502.

In some aspects, after activation or deactivation of OD-SIB1 for each NES cell, the NES network node 502 or the NES DU 401 may accordingly communicate with a UE, such as receiving UL-WUS from the UE and accordingly transmit OD-SIB1 for the UE. In some aspects, the NES network node 502 or the NES DU 401 may not broadcast OD-SIB1 without signaling from a UE.

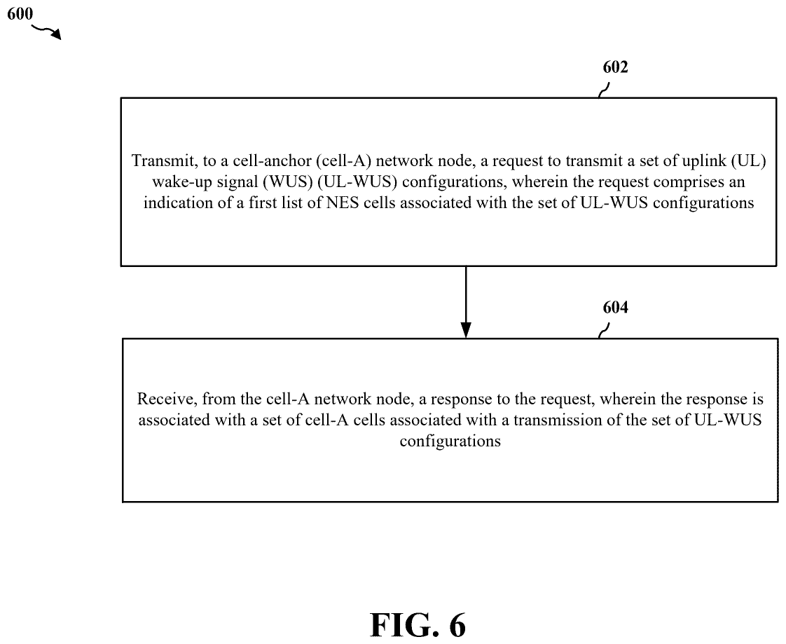

FIG. 6 is a flowchart 600 of a method of wireless communication. The method may be performed by an NES network node (e.g., the base station 102, the network entity 802, the network entity 960). The method may provide backhaul signaling mechanisms for transmission of UL-WUS configurations for NES cells.

At 602, the NES network node may transmit, to a cell-A network node, a request to transmit a set of UL-WUS configurations, where the request includes an indication of a first list of NES cells associated with the set of UL-WUS configurations. For example, the NES network node (e.g., 402 or 502) may transmit, to a cell-A network node, a request (e.g., 412 or 512) to transmit a set of UL-WUS configurations, where the request includes an indication of a first list of NES cells associated with the set of UL-WUS configurations. In some aspects, 602 may be performed by configuration component 199.

At 604, the NES network node may receive, from the cell-A network node, a response to the request, where the response is associated with a set of cell-A cells associated with a transmission of the set of UL-WUS configurations. For example, the NES network node (e.g., 402 or 502) may receive, from the cell-A network node, a response (e.g., 422 or 522) to the request, where the response is associated with a set of cell-A cells associated with a transmission of the set of UL-WUS configurations. In some aspects, 604 may be performed by configuration component 199.

In some aspects, the request includes the set of UL-WUS configurations or a set of indexes to the set of UL-WUS configurations. In some aspects, the request further includes a second indication of a second list of requested cell-A cells requested to be associated with the transmission of the set of UL-WUS configurations. In some aspects, the response to the request includes, for each NES cell or each NES cell group of the first list of NES cells, a third list of cell-A cells confirmed for the transmission of at least one UL-WUS configuration of the set of UL-WUS configurations. In some aspects, the response to the request includes, for each NES cell or each NES cell group of the first list of NES cells, a fourth list of cell-A cells rejected for the transmission of at least one UL-WUS configuration of the set of UL-WUS configurations, where each cell-A cell in the fourth list of cell-A cells corresponds to a respective requested cell-A cell in the second list of requested cell-A cells. In some aspects, the response to the request includes, for each NES cell or each NES cell group of the first list of NES cells, a fifth list of cell-A cells associated with cease the transmission of the set of UL-WUS configurations. In some aspects, the response to the request includes, for each NES cell or each NES cell group of the first list of NES cells, at least one indicator that indicates a confirmation, a rejection, or a cease for the transmission of the set of UL-WUS configurations for the second list of requested cell-A cells. In some aspects, the response to the request includes, for each cell-A cell of the set of cell-A cells, a third list of NES cells confirmed for the transmission of at least one UL-WUS configuration of the set of UL-WUS configurations. In some aspects, the response to the request includes, for each cell-A cell of the set of cell-A cells, a fourth list of NES cells rejected for the transmission of at least one UL-WUS configuration of the set of UL-WUS configurations. In some aspects, the response to the request includes, for each cell-A cell of the set of cell-A cells, a fifth list of NES cells associated with cease the transmission of the set of UL-WUS configurations. In some aspects, the response to the request includes, for each UL-WUS configuration of the set of UL-WUS configurations, at least one indicator that indicates a confirmation, a rejection, or a cease for the transmission of at least one UL-WUS configuration of the set of UL-WUS configurations for a transmission of at least one respective NES cell associated with the cell-A cell. In some aspects, the response to the request includes, for each UL-WUS configuration of the set of UL-WUS configurations, a third list of cell-A cells confirmed for the transmission of the UL-WUS configuration. In some aspects, the response to the request includes, for each UL-WUS configuration of the set of UL-WUS configurations, a fourth list of cell-A cells rejected for the transmission of the UL-WUS configuration. In some aspects, the response to the request includes, for each UL-WUS configuration of the set of UL-WUS configurations, a fifth list of cell-A cells associated with cease the transmission of the UL-WUS configurations. In some aspects, the response to the request includes, for each UL-WUS configuration of the set of UL-WUS configurations, at least one indicator that indicates a confirmation, a rejection, or a cease for the transmission of the UL-WUS configuration.

In some aspects, the set of indexes includes a respective index value associated with each UL-WUS configuration of the set of UL-WUS configurations, each cell-A cell of the set of cell-A cells, or each NES cell of the first list of NES cells. In some aspects, the response includes at least one indication based on the index value. In some aspects, the request is without a second indication a second list of requested cell-A cells requested to be associated with the transmission of the set of UL-WUS configurations. In some aspects, the NES network node is a NES CU, and the NES network node may receive, from a NES distributed unit (DU), a message indicating the first list of NES cells. In some aspects, the NES CU may transmit, to the NES DU, an activation or a deactivation of on-demand system information block 1 (SIB 1) for each NES cell of the first list of NES cells based on a respective cell identifier (ID). In some aspects, the message further includes a second list of cell-A cells associated with the transmission of the set of UL-WUS configurations. In some aspects, the NES CU may transmit, to the cell-A network node before the transmission of the request to transmit the set of UL-WUS configurations, a request for a list of candidate cell-A cells associated with the network node. In some aspects, the NES CU may receive, from the cell-A network node, the list of candidate cell-A cells, where the set of cell-A cells is based on the list of candidate cell-A cells. In some aspects, the network node may transmit, to the cell-A network node, information of the first list of NES cells. In some aspects, the network node may transmit receive, from the NES DU, information of the first list of NES cells.

In some aspects, the request or the response includes a set of time attribute parameters associated with a start, a stop, or a duration of each respective field in the request or the response. In some aspects, the network node may receive, from a neighbor network node, information of the set of cell-A cells.

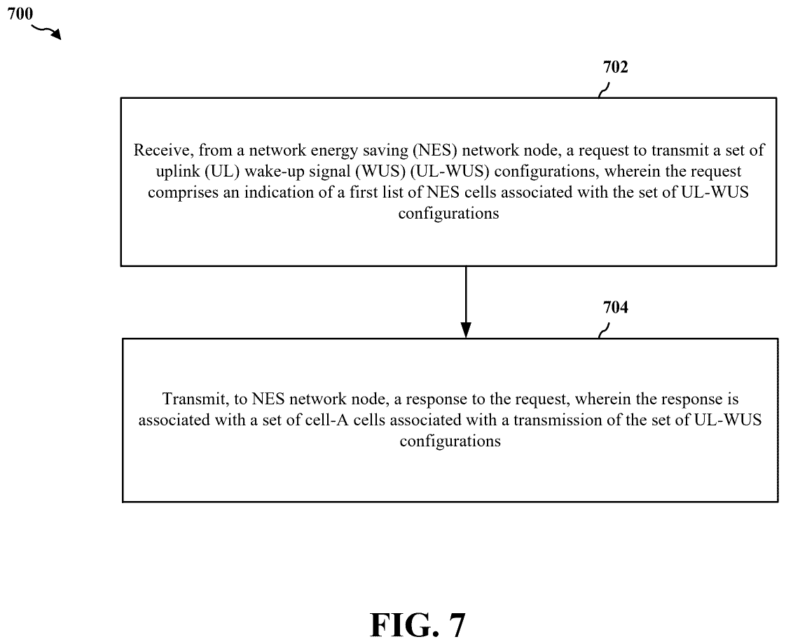

FIG. 7 is a flowchart 700 of a method of wireless communication. The method may be performed by a cell-A network node (e.g., the base station 102, the network entity 802, the network entity 960). The method may provide backhaul signaling mechanisms for transmission of UL-WUS configurations for NES cells.

At 702, the cell-A network node may receive, from an NES network node, a request to transmit a set of UL-WUS configurations, where the request includes an indication of a first list of NES cells associated with the set of UL-WUS configurations. For example, the cell-A network node (e.g., 404 or 504) may receive, from an NES network node, a request (e.g., 412 or 512) to transmit a set of UL-WUS configurations, where the request includes an indication of a first list of NES cells associated with the set of UL-WUS configurations. In some aspects, 702 may be performed by configuration component 199.

At 704, the cell-A network node may transmit, to NES network node, a response to the request, where the response is associated with a set of cell-A cells associated with a transmission of the set of UL-WUS configurations. For example, the cell-A network node (e.g., 404 or 504) may transmit, to NES network node, a response (e.g., 422 or 522) to the request, where the response is associated with a set of cell-A cells associated with a transmission of the set of UL-WUS configurations. In some aspects, 704 may be performed by configuration component 199.

In some aspects, the request includes the set of UL-WUS configurations or a set of indexes to the set of UL-WUS configurations (e.g., UL-WUS configurations may be provided in a separate message). In some aspects, the request further includes a second indication of a second list of requested cell-A cells requested to be associated with the transmission of the set of UL-WUS configurations. In some aspects, the response to the request includes, for each NES cell or each NES cell group of the first list of NES cells, a third list of cell-A cells confirmed for the transmission of at least one UL-WUS configuration of the set of UL-WUS configurations. In some aspects, the response to the request includes, for each NES cell or each NES cell group of the first list of NES cells, a fourth list of cell-A cells rejected for the transmission of at least one UL-WUS configuration of the set of UL-WUS configurations, where each cell-A cell in the fourth list of cell-A cells corresponds to a respective requested cell-A cell in the second list of requested cell-A cells. In some aspects, the response to the request includes, for each NES cell or each NES cell group of the first list of NES cells, a fifth list of cell-A cells associated with cease the transmission of the set of UL-WUS configurations. In some aspects, the response to the request includes, for each NES cell or each NES cell group of the first list of NES cells, at least one indicator that indicates a confirmation, a rejection, or a cease for the transmission of the set of UL-WUS configurations for the second list of requested cell-A cells. In some aspects, the response to the request includes, for each cell-A cell of the set of cell-A cells, a third list of NES cells confirmed for the transmission of at least one UL-WUS configuration of the set of UL-WUS configurations. In some aspects, the response to the request includes, for each cell-A cell of the set of cell-A cells, a fourth list of NES cells rejected for the transmission of at least one UL-WUS configuration of the set of UL-WUS configurations. In some aspects, the response to the request includes, for each cell-A cell of the set of cell-A cells, a fifth list of NES cells associated with cease the transmission of the set of UL-WUS configurations. In some aspects, the response to the request includes, for each UL-WUS configuration of the set of UL-WUS configurations, at least one indicator that indicates a confirmation, a rejection, or a cease for the transmission of at least one UL-WUS configuration of the set of UL-WUS configurations for a transmission of at least one respective NES cell associated with the cell-A cell. In some aspects, the response to the request includes, for each UL-WUS configuration of the set of UL-WUS configurations, a third list of cell-A cells confirmed for the transmission of the UL-WUS configuration. In some aspects, the response to the request includes, for each UL-WUS configuration of the set of UL-WUS configurations, a fourth list of cell-A cells rejected for the transmission of the UL-WUS configuration. In some aspects, the response to the request includes, for each UL-WUS configuration of the set of UL-WUS configurations, a fifth list of cell-A cells associated with cease the transmission of the UL-WUS configurations. In some aspects, the response to the request includes, for each UL-WUS configuration of the set of UL-WUS configurations, at least one indicator that indicates a confirmation, a rejection, or a cease for the transmission of the UL-WUS configuration.

In some aspects, the set of indexes includes a respective index value associated with each UL-WUS configuration of the set of UL-WUS configurations, each cell-A cell of the set of cell-A cells, or each NES cell of the first list of NES cells. In some aspects, the response includes at least one indication based on the index value. In some aspects, the request is without a second indication a second list of requested cell-A cells requested to be associated with the transmission of the set of UL-WUS configurations.

In some aspects, the cell-A network node is a cell-A CU. In some aspects, the cell-A CU may transmit, to a cell-A distributed unit (DU), a message indicating the first list of NES cells that are requested for transmission of the set of UL-WUS configurations. In some aspects, the message further includes the second list of cell-A cells associated with the transmission of the set of UL-WUS configurations. In some aspects, the cell-A CU may receive, from the NES network node before the transmission of the request to transmit the set of UL-WUS configurations, a request for a list of candidate cell-A cells associated with the network node. In some aspects, the cell-A CU may transmit, to the NES network node, the list of candidate cell-A cells, where the set of cell-A cells is based on the list of candidate cell-A cells. In some aspects, the cell-A CU may receive, from the NES network node, information of the first list of NES cells. In some aspects, the cell-A CU may transmit, to the cell-A DU, information of the request. In some aspects, the cell-A CU may receive, from the cell-A DU, feedback of the request, where the response to the request includes information based on the feedback, and where the feedback of the request includes information that is identical to the response to the request. In some aspects, the request or the response includes a set of time attribute parameters associated with a start, a stop, or a duration of each respective field in the request or the response. In some aspects, the network node may receive, from a neighbor network node, information of the first list of NES cells.

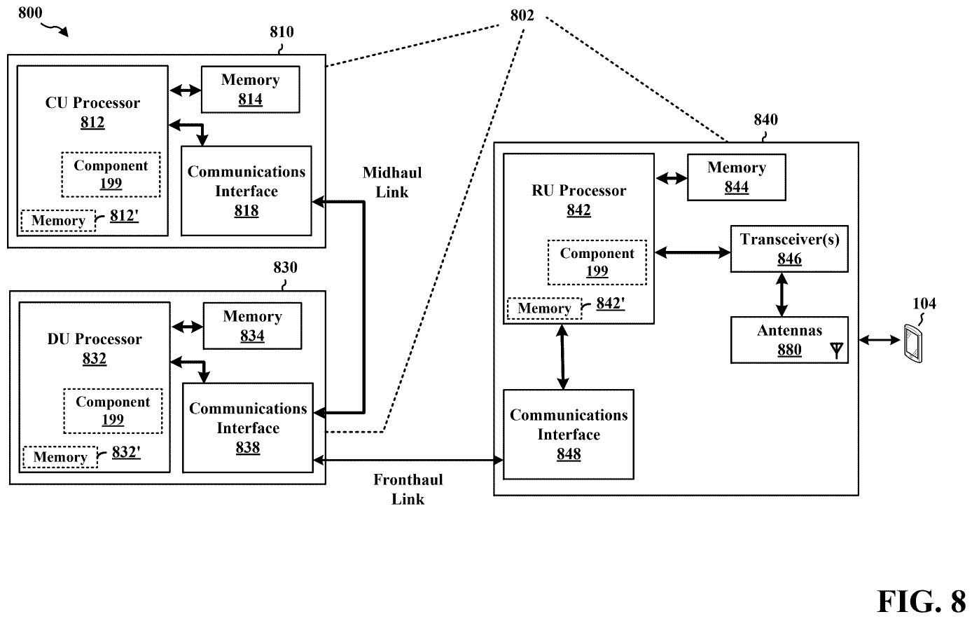

FIG. 8 is a diagram 800 illustrating an example of a hardware implementation for a network entity 802. The network entity 802 may be a BS, a component of a BS, or may implement BS functionality. The network entity 802 may include at least one of a CU 810, a DU 830, or an RU 840. For example, depending on the layer functionality handled by the component 199, the network entity 802 may include the CU 810; both the CU 810 and the DU 830; each of the CU 810, the DU 830, and the RU 840; the DU 830; both the DU 830 and the RU 840; or the RU 840. The CU 810 may include at least one CU processor 812. The CU processor(s) 812 may include on-chip memory 812′. In some aspects, the CU 810 may further include additional memory modules 814 and a communications interface 818. The CU 810 communicates with the DU 830 through a midhaul link, such as an F1 interface. The DU 830 may include at least one DU processor 832. The DU processor(s) 832 may include on-chip memory 832′. In some aspects, the DU 830 may further include additional memory modules 834 and a communications interface 838. The DU 830 communicates with the RU 840 through a fronthaul link. The RU 840 may include at least one RU processor 842. The RU processor(s) 842 may include on-chip memory 842′. In some aspects, the RU 840 may further include additional memory modules 844, one or more transceivers 846, antennas 880, and a communications interface 848. The RU 840 communicates with the UE 94. The on-chip memory 812′, 832′, 842′ and the additional memory modules 814, 834, 844 may each be considered a computer-readable medium/memory. Each computer-readable medium/memory may be non-transitory. Each of the processors 812, 832, 842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the configuration component 199 may be configured to transmit, to a cell-anchor (cell-A) network node, a request to transmit a set of uplink (UL) wake-up signal (WUS) (UL-WUS) configurations, where the request includes an indication of a first list of NES cells associated with the set of UL-WUS configurations. In some aspects, the configuration component 199 may be further configured to receive, from the cell-A network node, a response to the request, where the response is associated with a set of cell-A cells associated with a transmission of the set of UL-WUS configurations. In some aspects, the configuration component 199 may be configured to receive, from a network energy saving (NES) network node, a request to transmit a set of uplink (UL) wake-up signal (WUS) (UL-WUS) configurations, where the request includes an indication of a first list of NES cells associated with the set of UL-WUS configurations. In some aspects, the configuration component 199 may be further configured to transmit, to NES network node, a response to the request, where the response is associated with a set of cell-A cells associated with a transmission of the set of UL-WUS configurations.

The configuration component 199 may be within one or more processors of one or more of the CU 810, DU 830, and the RU 840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 802 may include a variety of components configured for various functions. In some aspects, the network entity 802 may include means for transmitting, to a cell-anchor (cell-A) network node, a request to transmit a set of uplink (UL) wake-up signal (WUS) (UL-WUS) configurations, where the request includes an indication of a first list of NES cells associated with the set of UL-WUS configurations. In some aspects, the network entity 802 may include means for receiving, from the cell-A network node, a response to the request, where the response is associated with a set of cell-A cells associated with a transmission of the set of UL-WUS configurations. In some aspects, the network entity 802 may include means for receiving, from a NES distributed unit (DU), a message indicating the first list of NES cells. In some aspects, the network entity 802 may include means for transmitting, to the NES DU, an activation or a deactivation of on-demand system information block 1 (SIB1) for each NES cell of the first list of NES cells based on a respective cell identifier (ID). In some aspects, the network entity 802 may include means for transmitting, to the cell-A network node before the transmission of the request to transmit the set of UL-WUS configurations, a request for a list of candidate cell-A cells associated with the network node. In some aspects, the network entity 802 may include means for transmitting, to the cell-A network node, information of the first list of NES cells. In some aspects, the network entity 802 may include means for receiving, from the NES DU, information of the first list of NES cells. In some aspects, the network entity 802 may include means for receiving, from a neighbor network node, information of the set of cell-A cells.

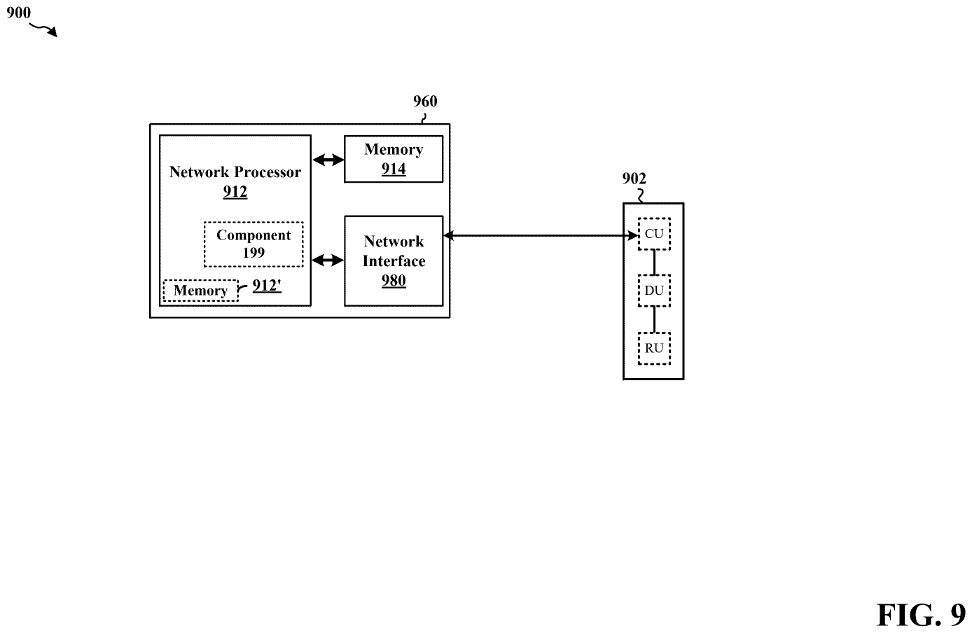

In some aspects, the network entity 802 may include means for receiving, from a network energy saving (NES) network node, a request to transmit a set of uplink (UL) wake-up signal (WUS) (UL-WUS) configurations, where the request includes an indication of a first list of NES cells associated with the set of UL-WUS configurations. In some aspects, the network entity 802 may include means for transmitting, to NES network node, a response to the request, where the response is associated with a set of cell-A cells associated with a transmission of the set of UL-WUS configurations. In some aspects, the network entity 802 may include means for transmitting, to a cell-A distributed unit (DU), a message indicating the first list of NES cells that are requested for transmission of the set of UL-WUS configurations. In some aspects, the network entity 802 may include means for receiving, from the NES network node before the transmission of the request to transmit the set of UL-WUS configurations, a request for a list of candidate cell-A cells associated with the network node. In some aspects, the network entity 802 may include means for transmitting, to the NES network node, the list of candidate cell-A cells, where the set of cell-A cells is based on the list of candidate cell-A cells. In some aspects, the network entity 802 may include means for receiving, from the NES network node, information of the first list of NES cells. In some aspects, the network entity 802 may include means for transmitting, to the cell-A DU, information of the request. In some aspects, the network entity 802 may include means for receiving, from the cell-A DU, feedback of the request, where the response to the request includes information based on the feedback, and where the feedback of the request includes information that is identical to the response to the request. The means may be the component 199 of the network entity 802 configured to perform the functions recited by the means. As described supra, the network entity 802 may include the TX processor 316, the RX processor 370, and the controller/processor 375. As such, in one configuration, the means may be the TX processor 316, the RX processor 370, and/or the controller/processor 375 configured to perform the functions recited by the means. FIG. 9 is a diagram 900 illustrating an example of a hardware implementation for a network entity 960. In one example, the network entity 960 may be within the core network 120. The network entity 960 may include at least one network processor 912. The network processor(s) 912 may include on-chip memory 912′. In some aspects, the network entity 960 may further include additional memory modules 914. The network entity 960 communicates via the network interface 980 directly (e.g., backhaul link) or indirectly (e.g., through a RIC) with the CU 902. The on-chip memory 912′ and the additional memory modules 914 may each be considered a computer-readable medium/memory. Each computer-readable medium/memory may be non-transitory. The network processor(s) 912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the configuration component 199 may be configured to transmit, to a cell-anchor (cell-A) network node, a request to transmit a set of uplink (UL) wake-up signal (WUS) (UL-WUS) configurations, where the request includes an indication of a first list of NES cells associated with the set of UL-WUS configurations. In some aspects, the configuration component 199 may be further configured to receive, from the cell-A network node, a response to the request, where the response is associated with a set of cell-A cells associated with a transmission of the set of UL-WUS configurations. In some aspects, the configuration component 199 may be configured to receive, from a network energy saving (NES) network node, a request to transmit a set of uplink (UL) wake-up signal (WUS) (UL-WUS) configurations, where the request includes an indication of a first list of NES cells associated with the set of UL-WUS configurations. In some aspects, the configuration component 199 may be further configured to transmit, to NES network node, a response to the request, where the response is associated with a set of cell-A cells associated with a transmission of the set of UL-WUS configurations.

The component 199 may be within the network processor(s) 912. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 960 may include a variety of components configured for various functions. In some aspects, the network entity 960 may include means for transmitting, to a cell-anchor (cell-A) network node, a request to transmit a set of uplink (UL) wake-up signal (WUS) (UL-WUS) configurations, where the request includes an indication of a first list of NES cells associated with the set of UL-WUS configurations. In some aspects, the network entity 960 may include means for receiving, from the cell-A network node, a response to the request, where the response is associated with a set of cell-A cells associated with a transmission of the set of UL-WUS configurations. In some aspects, the network entity 960 may include means for receiving, from a NES distributed unit (DU), a message indicating the first list of NES cells. In some aspects, the network entity 960 may include means for transmitting, to the NES DU, an activation or a deactivation of on-demand system information block 1 (SIB1) for each NES cell of the first list of NES cells based on a respective cell identifier (ID). In some aspects, the network entity 960 may include means for transmitting, to the cell-A network node before the transmission of the request to transmit the set of UL-WUS configurations, a request for a list of candidate cell-A cells associated with the network node. In some aspects, the network entity 960 may include means for transmitting, to the cell-A network node, information of the first list of NES cells. In some aspects, the network entity 960 may include means for receiving, from the NES DU, information of the first list of NES cells. In some aspects, the network entity 960 may include means for receiving, from a neighbor network node, information of the set of cell-A cells.

In some aspects, the network entity 960 may include means for receiving, from a network energy saving (NES) network node, a request to transmit a set of uplink (UL) wake-up signal (WUS) (UL-WUS) configurations, where the request includes an indication of a first list of NES cells associated with the set of UL-WUS configurations. In some aspects, the network entity 960 may include means for transmitting, to NES network node, a response to the request, where the response is associated with a set of cell-A cells associated with a transmission of the set of UL-WUS configurations. In some aspects, the network entity 960 may include means for transmitting, to a cell-A distributed unit (DU), a message indicating the first list of NES cells that are requested for transmission of the set of UL-WUS configurations. In some aspects, the network entity 960 may include means for receiving, from the NES network node before the transmission of the request to transmit the set of UL-WUS configurations, a request for a list of candidate cell-A cells associated with the network node. In some aspects, the network entity 960 may include means for transmitting, to the NES network node, the list of candidate cell-A cells, where the set of cell-A cells is based on the list of candidate cell-A cells. In some aspects, the network entity 960 may include means for receiving, from the NES network node, information of the first list of NES cells. In some aspects, the network entity 960 may include means for transmitting, to the cell-A DU, information of the request. In some aspects, the network entity 960 may include means for receiving, from the cell-A DU, feedback of the request, where the response to the request includes information based on the feedback, and where the feedback of the request includes information that is identical to the response to the request. The means may be the component 199 of the network entity 960 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a network energy saving (NES) network node, including: at least one memory; and at least one processor coupled to the at least one memory, and based at least in part on information stored in the at least one memory, the at least one processor is configured to: transmit, to a cell-anchor (cell-A) network node, a request to transmit a set of uplink (UL) wake-up signal (WUS) (UL-WUS) configurations, where the request includes an indication of a first list of NES cells associated with the set of UL-WUS configurations; and receive, from the cell-A network node, a response to the request, where the response is associated with a set of cell-A cells associated with a transmission of the set of UL-WUS configurations.

Aspect 2 is the apparatus of aspect 1, where the request includes the set of UL-WUS configurations or a set of indexes to the set of UL-WUS configurations, where the request further includes a second indication of a second list of requested cell-A cells requested to be associated with the transmission of the set of UL-WUS configurations.

Aspect 3 is the apparatus of aspect 2, where the response to the request includes: for each NES cell or each NES cell group of the first list of NES cells, a third list of cell-A cells confirmed for the transmission of at least one UL-WUS configuration of the set of UL-WUS configurations.

Aspect 4 is the apparatus of any of aspects 2-3, where the response to the request includes: for each NES cell or each NES cell group of the first list of NES cells, a fourth list of cell-A cells rejected for the transmission of at least one UL-WUS configuration of the set of UL-WUS configurations, where each cell-A cell in the fourth list of cell-A cells corresponds to a respective requested cell-A cell in the second list of requested cell-A cells.

Aspect 5 is the apparatus of any of aspects 2-4, where the response to the request includes: for each NES cell or each NES cell group of the first list of NES cells, a fifth list of cell-A cells associated with cease the transmission of the set of UL-WUS configurations.

Aspect 6 is the apparatus of any of aspects 2-5, where the response to the request includes: for each NES cell or each NES cell group of the first list of NES cells, at least one indicator that indicates a confirmation, a rejection, or a cease for the transmission of the set of UL-WUS configurations for the second list of requested cell-A cells.

Aspect 7 is the apparatus of any of aspects 2-6, where the response to the request includes: for each cell-A cell of the set of cell-A cells, a third list of NES cells confirmed for the transmission of at least one UL-WUS configuration of the set of UL-WUS configurations.

Aspect 8 is the apparatus of any of aspects 2-7, where the response to the request includes: for each cell-A cell of the set of cell-A cells, a fourth list of NES cells rejected for the transmission of at least one UL-WUS configuration of the set of UL-WUS configurations.

Aspect 9 is the apparatus of any of aspects 2-8, where the response to the request includes: for each cell-A cell of the set of cell-A cells, a fifth list of NES cells associated with cease the transmission of the set of UL-WUS configurations.

Aspect 10 is the apparatus of any of aspects 2-9, where the response to the request includes: for each UL-WUS configuration of the set of UL-WUS configurations, at least one indicator that indicates a confirmation, a rejection, or a cease for the transmission of at least one UL-WUS configuration of the set of UL-WUS configurations for a transmission of at least one respective NES cell associated with the cell-A cell.

Aspect 11 is the apparatus of any of aspects 2-10, where the response to the request includes: for each UL-WUS configuration of the set of UL-WUS configurations, a third list of cell-A cells confirmed for the transmission of the UL-WUS configuration.

Aspect 12 is the apparatus of aspect 11, where the response to the request includes: for each UL-WUS configuration of the set of UL-WUS configurations, a fourth list of cell-A cells rejected for the transmission of the UL-WUS configuration.

Aspect 13 is the apparatus of aspect 12, where the response to the request includes: for each UL-WUS configuration of the set of UL-WUS configurations, a fifth list of cell-A cells associated with cease the transmission of the UL-WUS configurations.

Aspect 14 is the apparatus of any of aspects 2-13, where the response to the request includes: for each UL-WUS configuration of the set of UL-WUS configurations, at least one indicator that indicates a confirmation, a rejection, or a cease for the transmission of the UL-WUS configuration.

Aspect 15 is the apparatus of any of aspects 2-14, where the set of indexes includes a respective index value associated with each UL-WUS configuration of the set of UL-WUS configurations, each cell-A cell of the set of cell-A cells, or each NES cell of the first list of NES cells.

Aspect 16 is the apparatus of aspect 15, where the response includes at least one indication based on the index value.

Aspect 17 is the apparatus of any of aspects 1-16, where the request is without a second indication a second list of requested cell-A cells requested to be associated with the transmission of the set of UL-WUS configurations.

Aspect 18 is the apparatus of any of aspects 1, where the NES network node is a NES central unit (CU), and where the at least one processor is further configured to: receive, from a NES distributed unit (DU), a message indicating the first list of NES cells.

Aspect 19 is the apparatus of aspect 18, where the message further includes a second list of cell-A cells associated with the transmission of the set of UL-WUS configurations.

Aspect 20 is the apparatus of any of aspects 18-19, where the at least one processor is further configured to: transmit, to the NES DU, an activation or a deactivation of on-demand system information block 1 (SIB1) for each NES cell of the first list of NES cells.

Aspect 21 is the apparatus of any of aspects 18-20, where the at least one processor is further configured to: receive, from the cell-A network node, a list of candidate cell-A cells, where the set of cell-A cells is based on the list of candidate cell-A cells.

Aspect 22 is the apparatus of aspect 21, where the at least one processor is further configured to: transmit, to the cell-A network node, information of the first list of NES cells.

Aspect 23 is the apparatus of any of aspects 18-22, where the at least one processor is further configured to: receive, from the NES DU, information of the first list of NES cells.

Aspect 24 is the apparatus of any of aspects 1-23, where the request or the response includes a set of time attribute parameters associated with a start, a stop, or a duration of each respective field in the request or the response.

Aspect 25 is the apparatus of any of aspects 1-24, where the at least one processor is further configured to: receive, from a neighbor network node, information of the set of cell-A cells.

Aspect 26 is an apparatus for wireless communication at a cell-anchor (cell-A) network node, including: at least one memory; and at least one processor coupled to the at least one memory, and based at least in part on information stored in the at least one memory, the at least one processor is configured to: receive, from a network energy saving (NES) network node, a request to transmit a set of uplink (UL) wake-up signal (WUS) (UL-WUS) configurations, where the request includes an indication of a first list of NES cells associated with the set of UL-WUS configurations; and transmit, to NES network node, a response to the request, where the response is associated with a set of cell-A cells associated with a transmission of the set of UL-WUS configurations.

Aspect 27 is the apparatus of aspect 26, where the request includes the set of UL-WUS configurations or a set of indexes to the set of UL-WUS configurations, and where the request further includes a second indication of a second list of requested cell-A cells requested to be associated with the transmission of the set of UL-WUS configurations.

Aspect 28 is the apparatus of aspect 27, where the response to the request includes: for each NES cell or each NES cell group of the first list of NES cells, a third list of cell-A cells confirmed for the transmission of at least one UL-WUS configuration of the set of UL-WUS configurations.

Aspect 29 is the apparatus of aspect 28, where the response to the request includes: for each NES cell or each NES cell group of the first list of NES cells, a fourth list of cell-A cells rejected for the transmission of at least one UL-WUS configuration of the set of UL-WUS configurations, where each cell-A cell in the fourth list of cell-A cells corresponds to a respective requested cell-A cell in the second list of requested cell-A cells.

Aspect 30 is the apparatus of aspect 29, where the response to the request includes: for each NES cell or each NES cell group of the first list of NES cells, a fifth list of cell-A cells associated with cease the transmission of the set of UL-WUS configurations.

Aspect 31 is the apparatus of any of aspects 27-30, where the response to the request includes: for each NES cell or each NES cell group of the first list of NES cells, at least one indicator that indicates a confirmation, a rejection, or a cease for the transmission of the set of UL-WUS configurations for the second list of requested cell-A cells.

Aspect 32 is the apparatus of any of aspects 27-31, where the response to the request includes: for each cell-A cell of the set of cell-A cells, a third list of NES cells confirmed for the transmission of at least one UL-WUS configuration of the set of UL-WUS configurations.

Aspect 33 is the apparatus of any of aspects 27-32, where the response to the request includes: for each cell-A cell of the set of cell-A cells, a fourth list of NES cells rejected for the transmission of at least one UL-WUS configuration of the set of UL-WUS configurations.

Aspect 34 is the apparatus of any of aspects 27-33, where the response to the request includes: for each cell-A cell of the set of cell-A cells, a fifth list of NES cells associated with cease the transmission of the set of UL-WUS configurations.

Aspect 35 is the apparatus of any of aspects 27-34, where the response to the request includes: for each UL-WUS configuration of the set of UL-WUS configurations, at least one indicator that indicates a confirmation, a rejection, or a cease for the transmission of at least one UL-WUS configuration of the set of UL-WUS configurations for a transmission of at least one respective NES cell associated with the cell-A cell.

Aspect 36 is the apparatus of any of aspects 27-35, where the response to the request includes: for each UL-WUS configuration of the set of UL-WUS configurations, a third list of cell-A cells confirmed for the transmission of the UL-WUS configuration.

Aspect 37 is the apparatus of aspect 36, where the response to the request includes: for each UL-WUS configuration of the set of UL-WUS configurations, a fourth list of cell-A cells rejected for the transmission of the UL-WUS configuration.

Aspect 38 is the apparatus of aspect 37, where the response to the request includes: for each UL-WUS configuration of the set of UL-WUS configurations, a fifth list of cell-A cells associated with cease the transmission of the UL-WUS configurations.

Aspect 39 is the apparatus of any of aspects 27-38, where the response to the request includes: for each UL-WUS configuration of the set of UL-WUS configurations, at least one indicator that indicates a confirmation, a rejection, or a cease for the transmission of the UL-WUS configuration.

Aspect 40 is the apparatus of any of aspects 27, where the set of indexes includes a respective index value associated with each UL-WUS configuration of the set of UL-WUS configurations, each cell-A cell of the set of cell-A cells, or each NES cell of the first list of NES cells.

Aspect 41 is the apparatus of aspect 40, where the response includes at least one indication based on the index value.

Aspect 42 is the apparatus of any of aspects 27-41, where the request is without a second indication of a second list of requested cell-A cells requested to be associated with the transmission of the set of UL-WUS configurations.

Aspect 43 is the apparatus of any of aspects 27-44, where the cell-A network node is a cell-A central unit (CU), and where the at least one processor is further configured to: transmit, to a cell-A distributed unit (DU), a message indicating the first list of NES cells that are requested for transmission of the set of UL-WUS configurations.

Aspect 44 is the apparatus of aspect 43, where the message further includes the second list of cell-A cells associated with the transmission of the set of UL-WUS configurations.

Aspect 45 is the apparatus of any of aspects 43-44, where the at least one processor is further configured to: transmit, to the cell-A DU, the set of UL-WUS configurations or the set of indexes to the set of UL-WUS configurations.

Aspect 46 is the apparatus of any of aspects 43-45, where the at least one processor is further configured to: receive, from the NES network node before the transmission of the request to transmit the set of UL-WUS configurations, a request for a list of candidate cell-A cells associated with the network node; and transmit, to the NES network node, the list of candidate cell-A cells, where the set of cell-A cells is based on the list of candidate cell-A cells.

Aspect 47 is the apparatus of aspect 46, where the at least one processor is further configured to: receive, from the NES network node, information of the first list of NES cells.

Aspect 48 is the apparatus of any of aspects 43-47, where the at least one processor is further configured to: transmit, to the cell-A DU, information of the request; and receive, from the cell-A DU, feedback of the request, where the response to the request includes information based on the feedback, and where the feedback of the request includes information that is identical to the response to the request in any of claims 28-42.

Aspect 49 is the apparatus of any of aspects 26-48, where the request or the response includes a set of time attribute parameters associated with a start, a stop, or a duration of each respective field in the request or the response.

Aspect 50 is the apparatus of any of aspects 26-49, where the at least one processor is further configured to: receive, from a neighbor network node, information of the first list of NES cells.

Aspect 51 is a method of wireless communication for implementing any of aspects 1 to 25.

Aspect 52 is a computer-readable medium (e.g., a non-transitory computer-readable medium) storing computer executable code, the code when executed by at least one processor causes the at least one processor to implement any of aspects 1 to 25.

Aspect 53 is an apparatus comprising means for implementing any of aspects 1 to 25.

Aspect 54 is a method of wireless communication for implementing any of aspects 26 to 50.

Aspect 55 is a computer-readable medium (e.g., a non-transitory computer-readable medium) storing computer executable code, the code when executed by at least one processor causes the at least one processor to implement any of aspects 26 to 50.

Aspect 56 is an apparatus comprising means for implementing any of aspects 26 to 50.

What is claimed is:

1. An apparatus for wireless communication at a network energy saving (NES) network node, comprising:
at least one memory; and
at least one processor coupled to the at least one memory, and based at least in part on information stored in the at least one memory, the at least one processor is configured to:
transmit, to a cell-anchor (cell-A) network node, a request to transmit a set of uplink (UL) wake-up signal (WUS) (UL-WUS) configurations, wherein the request comprises an indication of a first list of NES cells associated with the set of UL-WUS configurations; and
receive, from the cell-A network node, a response to the request, wherein the response is associated with a set of cell-A cells associated with a transmission of the set of UL-WUS configurations.

2. The apparatus of claim 1, wherein the request comprises the set of UL-WUS configurations or a set of indexes to the set of UL-WUS configurations, wherein the request further comprises a second indication of a second list of requested cell-A cells requested to be associated with the transmission of the set of UL-WUS configurations.

3. The apparatus of claim 2, wherein the response to the request comprises:
for each NES cell or each NES cell group of the first list of NES cells, a third list of cell-A cells confirmed for the transmission of at least one UL-WUS configuration of the set of UL-WUS configurations.

4. The apparatus of claim 2, wherein the response to the request comprises:
for each NES cell or each NES cell group of the first list of NES cells, a fourth list of cell-A cells rejected for the transmission of at least one UL-WUS configuration of the set of UL-WUS configurations, wherein each cell-A cell in the fourth list of cell-A cells corresponds to a respective requested cell-A cell in the second list of requested cell-A cells.

5. The apparatus of claim 2, wherein the response to the request comprises:
for each NES cell or each NES cell group of the first list of NES cells, a fifth list of cell-A cells associated with cease the transmission of the set of UL-WUS configurations.

6. The apparatus of claim 2, wherein the response to the request comprises:
for each NES cell or each NES cell group of the first list of NES cells, at least one indicator that indicates a confirmation, a rejection, or a cease for the transmission of the set of UL-WUS configurations for the second list of requested cell-A cells.

7. The apparatus of claim 1, wherein the request is without a second indication a second list of requested cell-A cells requested to be associated with the transmission of the set of UL-WUS configurations.

8. The apparatus of claim 1, wherein the NES network node is a NES central unit (CU), and wherein the at least one processor is further configured to:
receive, from a NES distributed unit (DU), a message indicating the first list of NES cells.

9. The apparatus of claim 8, wherein the message further comprises a second list of cell-A cells associated with the transmission of the set of UL-WUS configurations.

10. The apparatus of claim 8, wherein the at least one processor is further configured to:
transmit, to the NES DU, an activation or a deactivation of on-demand system information block 1 (SIB1) for each NES cell of the first list of NES cells.

11. The apparatus of claim 8, wherein the at least one processor is further configured to:
receive, from the NES DU, information of the first list of NES cells.

12. The apparatus of claim 1, wherein the request or the response comprises a set of time attribute parameters associated with a start, a stop, or a duration of each respective field in the request or the response.

13. The apparatus of claim 1, wherein the at least one processor is further configured to:
receive, from a neighbor network node, information of the set of cell-A cells.

14. An apparatus for wireless communication at a cell-anchor (cell-A) network node, comprising:
at least one memory; and
at least one processor coupled to the at least one memory, and based at least in part on information stored in the at least one memory, the at least one processor is configured to:
receive, from a network energy saving (NES) network node, a request to transmit a set of uplink (UL) wake-up signal (WUS) (UL-WUS) configurations, wherein the request comprises an indication of a first list of NES cells associated with the set of UL-WUS configurations; and
transmit, to NES network node, a response to the request, wherein the response is associated with a set of cell-A cells associated with a transmission of the set of UL-WUS configurations.

15. The apparatus of claim 14, wherein the request comprises the set of UL-WUS configurations or a set of indexes to the set of UL-WUS configurations, and wherein the request further comprises a second indication of a second list of requested cell-A cells requested to be associated with the transmission of the set of UL-WUS configurations.

16. The apparatus of claim 15, wherein the response to the request comprises:
for each NES cell or each NES cell group of the first list of NES cells, a third list of cell-A cells confirmed for the transmission of at least one UL-WUS configuration of the set of UL-WUS configurations.

17. The apparatus of claim 15, wherein the cell-A network node is a cell-A central unit (CU), and wherein the at least one processor is further configured to:
transmit, to a cell-A distributed unit (DU), a message indicating the first list of NES cells that are requested for transmission of the set of UL-WUS configurations.

18. The apparatus of claim 17, wherein the at least one processor is further configured to:
transmit, to the cell-A DU, the set of UL-WUS configurations or the set of indexes to the set of UL-WUS configurations.

19. The apparatus of claim 17, wherein the request or the response comprises a set of time attribute parameters associated with a start, a stop, or a duration of each respective field in the request or the response.

20. A method for wireless communication performed by a network energy saving (NES) network node, comprising:
transmitting, to a cell-anchor (cell-A) network node, a request to transmit a set of uplink (UL) wake-up signal (WUS) (UL-WUS) configurations, wherein the request comprises an indication of a first list of NES cells associated with the set of UL-WUS configurations; and
receiving, from the cell-A network node, a response to the request, wherein the response is associated with a set of cell-A cells associated with a transmission of the set of UL-WUS configurations.
